(19) United States
(12) Patent Application Publication
(10) Pub. No.: US 2025/0253110 A1
(43) Pub. Date: Aug. 7, 2025

(54) CONTACTOR SYSTEM AND CONTACTOR CONTROL METHOD

(71) Applicant: HONDA MOTOR CO., LTD., Tokyo (JP)

(72) Inventor: Eisuke MATSUDA, Saitama (JP)

(21) Appl. No.: 19/022,594

(22) Filed: Jan. 15, 2025

(30) Foreign Application Priority Data
Feb. 6, 2024 (JP) 2024-016496

(51) Int. Cl. H01H 36/00; G01K 7/42; H02M 1/32

(52) U.S. Cl. CPC H01H 36/008; G01K 7/42; H02M 1/327

(57) ABSTRACT

A contactor system includes: a contactor provided on a power supply path connecting a power supply and a load, the contactor comprising a normally open movable contact for selectively establishing/interrupting the power supply path and an electromagnetic coil for driving the movable contact; a contactor driving circuit electrically connected to the electromagnetic coil to drive the contactor; a current sensor for detecting a contactor drive current flowing from the contactor driving circuit to the electromagnetic coil; and a controller configured to control the contactor driving circuit so as to apply a voltage to the electromagnetic coil to close the contactor and so as to stop voltage application to the electromagnetic coil to open the contactor, wherein the controller is configured to estimate a coil temperature of the electromagnetic coil based on the contactor drive current detected by the current sensor.

### TECHNICAL FIELD

The present invention relates to a contactor system and a contactor control method.

### BACKGROUND ART

In recent years, efforts to realize a low-carbon society or a carbon-neutral society are becoming more active, and in relation to vehicles, research and development on electrification technology are being conducted to reduce CO₂ emission and to improve energy efficiency. To improve the driving performance of electric vehicles, it is important to stably supply electric power from the power supply to the load such as an electric motor, an inverter, or the like.

To prevent excessive electric power from being supplied to the load when any abnormality occurs in the electric circuit, a contactor is provided in the power supply path. Further, to smooth the electric power supplied to the load, a smoothing capacitor is provided in the power supply path.

For example, JP7120072B2 discloses a converter system in which a main contactor is provided in a power supply path from a battery to a DC/DC converter, which is a load, and a smoothing capacitor is connected in parallel with the load. This system includes a precharge contactor connected in parallel with the main contactor via a resistor, voltage sensors for detecting the voltages of the battery and the capacitor, respectively, a current sensor for detecting electric current flowing from the battery to the load, and a control unit. The control unit controls precharge of the capacitor by opening and closing the precharge contactor and also controls opening and closing of the main contactor. The control unit determines that the precharge is completed when the current detected by the current sensor is less than or equal to a threshold current.

However, in the aforementioned conventional technology, there is a possibility that the temperature of the coil in the contactor may excessively rise when the contactor is in the closed state. This may cause the coil resistance to increase to such a degree that the electric current flowing through the coil becomes insufficient, whereby a malfunction that the contactor opens inadvertently may occur. To monitor the coil temperature to prevent the open malfunction of the contactor, it may be conceived to provide a thermistor in the contactor, but such a configuration of the contactor system would considerably increase the cost of the contactor system.

### SUMMARY OF THE INVENTION

In view of the foregoing background, a primary object of the present invention is to achieve both prevention of the open malfunction of the contactor due to a rise in the coil temperature when the contactor is closed and suppression of increase of cost of the contactor system.

To achieve the above object, one aspect of the present invention provides a contactor system (1), comprising: a contactor (6) provided on a power supply path (4) connecting a power supply (2) and a load (5), the contactor comprising a normally open movable contact (13) for selectively establishing/interrupting the power supply path and an electromagnetic coil (14) for driving the movable contact; a contactor driving circuit (15) electrically connected to the electromagnetic coil to drive the contactor; a current sensor (19) for detecting a contactor drive current flowing from the contactor driving circuit to the electromagnetic coil; and a controller (10) configured to control the contactor driving circuit so as to apply a voltage to the electromagnetic coil to close the contactor and so as to stop voltage application to the electromagnetic coil to open the contactor, wherein the controller is configured to estimate a coil temperature (T) of the electromagnetic coil based on the contactor drive current detected by the current sensor (ST6).

According to this aspect, since the controller estimates the coil temperature of the electromagnetic coil based on the contactor drive current (electric current detection value) detected by the current sensor, the open malfunction of the contactor can be prevented without providing a thermistor in the contactor.

In the above aspect, preferably, the controller calculates a resistance of the electromagnetic coil based on the voltage applied to the electromagnetic coil and the contactor drive current, and estimates the coil temperature of the electromagnetic coil based on the resistance.

According to this aspect, the controller can accurately estimate the coil temperature of the electromagnetic coil based on the resistance of the coil.

In the above aspect, preferably, the controller estimates the coil temperature by referring to a map showing a relationship between the resistance and the coil temperature.

According to this aspect, the controller can accurately estimate the coil temperature of the electromagnetic coil without performing complicated calculations.

In the above aspect, preferably, the controller increases the voltage applied to the electromagnetic coil (ST9) when the coil temperature exceeds a first threshold temperature (Tth1) that is set beforehand (ST15: Yes).

According to this aspect, it is possible to prevent the open malfunction of the contactor due to a rise in the coil temperature while maintaining the conduction of the power supply path.

In the above aspect, preferably, the controller controls the contactor driving circuit to stop the voltage application to the electromagnetic coil (ST11) when the coil temperature exceeds a second threshold temperature (Tth2) that is set beforehand (ST17: Yes).

According to this aspect, the contactor can be opened to interrupt the power supply path before the open malfunction of the contactor due to a rise in the coil temperature occurs.

In the above aspect, preferably, the controller controls the contactor driving circuit to stop the voltage application to the electromagnetic coil (ST11) when the coil temperature exceeds a second threshold temperature (Tth2) that is set beforehand (ST17: Yes), the second threshold temperature being higher than the first threshold temperature.

According to this aspect, it is possible to maintain the conduction of the power supply path while preventing the open malfunction of the contactor due to a rise in the coil temperature, and when the coil temperature becomes higher, it is possible to interrupt the power supply path to reliably prevent the open malfunction of the contactor.

To achieve the above object, another aspect of the present invention provides a contactor control method in a contactor system (1), the contactor system comprising: a contactor (6) provided on a power supply path (4) connecting a power supply (2) and a load (5), the contactor comprising a normally open movable contact (13) for selectively establishing/interrupting the power supply path and an electromagnetic coil (14) for driving the movable contact; a contactor driving circuit (15) electrically connected to the electromagnetic coil to drive the contactor; and a current sensor (19) for detecting a contactor drive current flowing from the contactor driving circuit to the electromagnetic coil, the contactor control method comprising: controlling the contactor driving circuit to apply a voltage to the electromagnetic coil when to close the contactor and to stop voltage application to the electromagnetic coil when to open the contactor; estimating a coil temperature (T) of the electromagnetic coil based on the contactor drive current detected by the current sensor (ST6); and controlling the contactor driving circuit according to the coil temperature (ST4, ST9, ST11).

According to this aspect, since the controller estimates the coil temperature of the electromagnetic coil based on the contactor drive current (electric current detection value) detected by the current sensor, the open malfunction of the contactor can be prevented without providing a thermistor in the contactor.

In the above aspect, preferably, the contactor driving circuit is controlled to increase the voltage applied to the electromagnetic coil (ST9) when the coil temperature exceeds a first threshold temperature (Tth1) that is set beforehand (ST15: Yes).

According to this aspect, it is possible to prevent the open malfunction of the contactor due to a rise in the coil temperature while maintaining the conduction of the power supply path.

In the above aspect, preferably, the contactor driving circuit is controlled to stop the voltage application to the electromagnetic coil (ST11) when the coil temperature exceeds a second threshold temperature (Tth2) that is set beforehand (ST17: Yes).

According to this aspect, the contactor can be opened to interrupt the power supply path before the open malfunction of the contactor due to a rise in the coil temperature occurs.

In the above aspect, preferably, the contactor driving circuit is controlled to stop the voltage application to the electromagnetic coil (ST11) when the coil temperature exceeds a second threshold temperature (Tth2) that is set beforehand (ST17: Yes), the second threshold temperature being higher than the first threshold temperature.

According to this aspect, it is possible to maintain the conduction of the power supply path while preventing the open malfunction of the contactor due to a rise in the coil temperature, and when the coil temperature becomes higher, it is possible to interrupt the power supply path to reliably prevent the open malfunction of the contactor.

According to the above aspect, it is possible to prevent the open malfunction of the contactor due to a rise in the coil temperature when the contactor is closed.

### BRIEF DESCRIPTION OF THE DRAWINGS

FIG. 1 is a block diagram showing a functional configuration of a converter system provided with a contactor system according to an embodiment;

FIG. 2 is a map showing a correlation between a coil resistance and a coil temperature;

FIG. 3 is a flowchart showing a procedure of contactor control performed by an ECU; and

FIG. 4 is a block diagram showing a functional configuration of a converter system according to a comparative example.

### DETAILED DESCRIPTION OF THE INVENTION

In the following, a contactor system according to an embodiment of the present invention will be described in detail with reference to the drawings. The following embodiment is described as an example in which the present invention is applied to an automobile. The automobile may be a hybrid car, a fuel cell vehicle, an electric car, or the like.

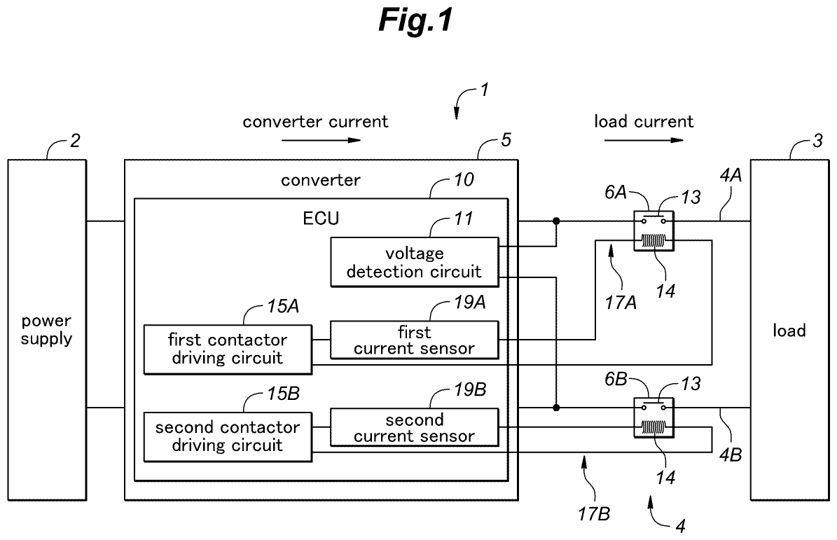

FIG. 1 is a block diagram showing a functional configuration of a converter system 1 provided with a contactor system according to the embodiment. As shown in FIG. 1, the converter system 1 includes a power supply 2, a load 3, and a first power supply path 4 (4A, 4B) connecting the power supply 2 and the load 3. A converter 5 is provided on the first power supply path 4, namely, between the power supply 2 and the load 3 in the first power supply path 4, and contactors 6 (6A, 6B) are provided between the converter 5 and the load 3 in the first power supply path 4. Namely, it can be said that the converter system 1 is a contactor system including the contactors 6.

The power supply 2 is composed of a power supply device mounted on the automobile. The power supply device may be a battery fixed to the automobile, a portable battery configured to be detachable from the automobile, a fuel cell, or the like. The battery may be a lithium ion battery, a nickel hydrogen battery, etc. The power supply 2 is a DC power supply that outputs DC electric power, and supplies DC electric power to the converter 5.

The load 3 is a traveling motor, an inverter, etc. of the automobile, for example. The traveling motor may be an AC motor or a DC motor provided with permanent magnets. In the case where the traveling motor is an AC motor, the load 3 includes a traveling motor and an inverter. The traveling motor functions as a drive motor when the automobile is power running and functions as an electric generator during braking of the automobile.

For example, the inverter may be configured as a three-phase bridge inverter. When the automobile is power running, DC electric power is supplied from the power supply 2 to the inverter via the converter 5. The inverter converts the DC electric power to three-phase AC electric power and supplies the AC electric power to the traveling motor. As a result of the driving of the traveling motor, the driving wheels are rotationally driven and the automobile travels.

The converter 5 is a DC/DC converter and includes an electronic control unit (ECU) 10 (one example of the controller). Further, in the converter 5, a capacitor for smoothing the output voltage is connected in parallel with the load 3. The ECU 10 controls the converter 5 to boost the DC electric power supplied from the power supply 2. As a result of the ECU 10 adjusting the output voltage to be applied to the load 3 to a desired value, the drive current supplied to the load 3 via the first power supply path 4 is adjusted.

On the other hand, when the traveling automobile is braked, the inverter is regeneratively operated so as to make the traveling motor function as an electric generator, and converts the AC electric power generated by the traveling motor to DC electric power. The high-voltage DC electric power converted by the inverter is stepped down via the converter 5 and is supplied to the power supply 2. Thereby, the power supply 2 is charged. As a result of the ECU 10 adjusting the charging voltage to be applied to the power supply 2 to a desired value, the charging electric current supplied to the power supply 2 is adjusted.

The ECU 10 consists of a computer including a processor (a processing unit such as a CPU, an MPU, etc.) and a memory (a storage device such as a ROM, a RAM, etc.) and is configured to execute various processes necessary to control the converter 5, etc. The processor is configured to read necessary data and software from the memory according to execution commands from external devices, such as an input device, and to execute predetermined computational processing according to the software. The ECU 10 may be configured as one piece of hardware or may be configured as a unit including multiple pieces of hardware.

Further, the ECU 10 is provided with a voltage detection circuit 11 for detecting the voltage outputted from the converter 5 to the first power supply path 4. The first power supply path 4 is configured by a positive power line 4A and a negative power line 4B. The voltage detection circuit 11 is connected to the positive power line 4A and the negative power line 4B of the first power supply path 4.

The ECU 10 stores a preset overvoltage threshold. When the detection result of the voltage detection circuit 11 exceeds the overvoltage threshold during operation of the converter 5, the ECU 10 determines that an abnormality occurs in the voltage outputted from the converter 5 to the load 3 and stops the converter 5. Note, however, that there is a stop delay of a predetermined time from the time point when the output voltage of the converter 5 exceeds the overvoltage threshold to when the converter 5 is actually stopped.

The contactors 6 are each an electromagnetic contactor for selectively establishing/interrupting the first power supply path 4, and in the present embodiment, two contactors 6 (hereinafter referred to as a first contactor 6A and a second contactor 6B) are provided. The first contactor 6A is provided in the positive power line 4A of the first power supply path 4, and the second contactor 6B is provided in the negative power line 4B of the first power supply path 4. Each contactor 6 includes a movable contact 13 (contact point) which can selectively take an open state and a closed state and an electromagnetic coil 14 for driving the movable contact 13. Each contactor 6 is a normally open electromagnetic contactor in which the movable contact 13 opens to interrupt the first power supply path 4 when the electromagnetic coil 14 is not energized, and the movable contact 13 is closed to establish the first power supply path 4 when the electromagnetic coil 14 is energized.

In the case where a contactor 6 is provided in the first power supply path 4, a malfunction in which the contactor 6 is fixed in the closed state may occur. In the present embodiment, since two contactors 6 including the first contactor 6A and the second contactor 6B are provided, even if one contactor 6 is fixed in the closed state, the electric power supply to the load 3 can be stopped by opening the other contactor 6.

Each contactor 6 is controlled by the ECU 10 of the converter 5. The ECU 10 includes a first contactor driving circuit 15A for driving the first contactor 6A and a second contactor driving circuit 15B for driving the second contactor 6B. The first contactor driving circuit 15A is electrically connected to the electromagnetic coil 14 of the first contactor 6A via a first contactor power supply path 17A. The second contactor driving circuit 15B is electrically connected to the electromagnetic coil 14 of the second contactor 6B via a second contactor power supply path 17B. Each contactor driving circuit 15A, 15B selectively applies a voltage to the electromagnetic coil 14 of the corresponding contactor 6 to control the contactor drive current flowing through the electromagnetic coil 14, thereby opening and closing the movable contact 13.

Further, the ECU 10 includes a first current sensor 19A for detecting the contactor drive current flowing from the first contactor driving circuit 15A to the corresponding electromagnetic coil 14 and a second current sensor 19B for detecting the contactor drive current flowing from the second contactor driving circuit 15B to the corresponding electromagnetic coil 14. The first contactor driving circuit 15A supplies the contactor drive current to the electromagnetic coil 14 to close the first contactor 6A when the converter 5 is in operation, and stops supplying the contactor drive current to the electromagnetic coil 14 to open the first contactor 6A when the converter 5 is stopped. The second contactor driving circuit 15B supplies the contactor drive current to the electromagnetic coil 14 to close the second contactor 6B when the converter 5 is in operation, and stops supplying the contactor drive current to the electromagnetic coil 14 to open the second contactor 6B when the converter 5 is stopped.

While in operation, the ECU 10 estimates a coil temperature T of the electromagnetic coil 14 of the first contactor 6A based on a first electric current detection value detected by the first current sensor 19A. Further, while in operation, the ECU 10 estimates a coil temperature T of the electromagnetic coil 14 of the second contactor 6B based on a second electric current detection value detected by the second current sensor 19B.

Thus, based on the electric current detection value detected by each current sensor 19, the ECU 10 estimates the coil temperature T of the corresponding electromagnetic coil 14, and therefore, it is possible to prevent the open malfunction of the contactor 6 without providing a thermistor in each contactor 6.

Specifically, the ECU 10 calculates the resistance of the electromagnetic coil 14 based on the voltage applied to the electromagnetic coil 14 by each contactor driving circuit 15 and the electric current detection value detected by the corresponding current sensor 19. Subsequently, the ECU 10 estimates the coil temperature T of the electromagnetic coil 14 based on the calculated resistance of the electromagnetic coil 14. Since the ECU 10 estimates the coil temperature T based on the resistance of the electromagnetic coil 14 as described above, the coil temperature T of the electromagnetic coil 14 is estimated accurately.

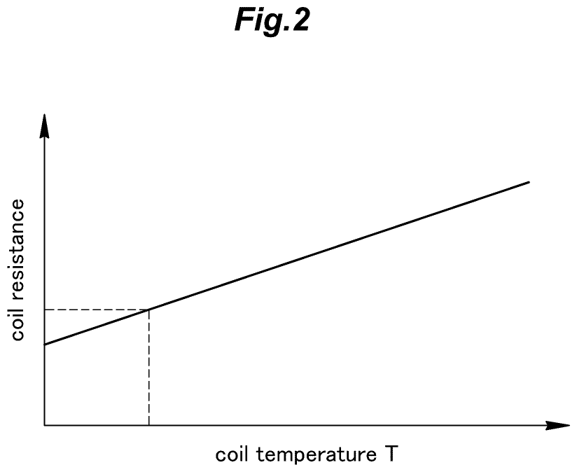

In the present embodiment, the ECU 10 estimates the coil temperature T by referring to a map showing a relationship between the resistance of the electromagnetic coil 14 and the coil temperature T. FIG. 2 is a map showing a correlation between the resistance of the electromagnetic coil 14 and the coil temperature T. As shown in FIG. 2, there is a certain relationship between the resistance of the electromagnetic coil 14 and the coil temperature T. Thus, a map as shown in FIG. 2 that is created beforehand based on experimental results, etc. is stored in the memory of the ECU 10. Multiple maps corresponding to elements other than the resistance of the electromagnetic coil 14, such as the outside temperature, the cooling water temperature, etc. that may affect the coil temperature T may be stored in the memory of the ECU 10. By referring to this map, the ECU 10 derives the coil temperature T from the resistance of the electromagnetic coil 14. By estimating the coil temperature T by referring to the map as described above, the ECU 10 can accurately estimate the coil temperature T of the electromagnetic coil 14 without performing complicated calculations.

Then, the ECU 10 controls the first contactor driving circuit 15A, the second contactor driving circuit 15B, and the converter 5 based on these estimated coil temperatures T.

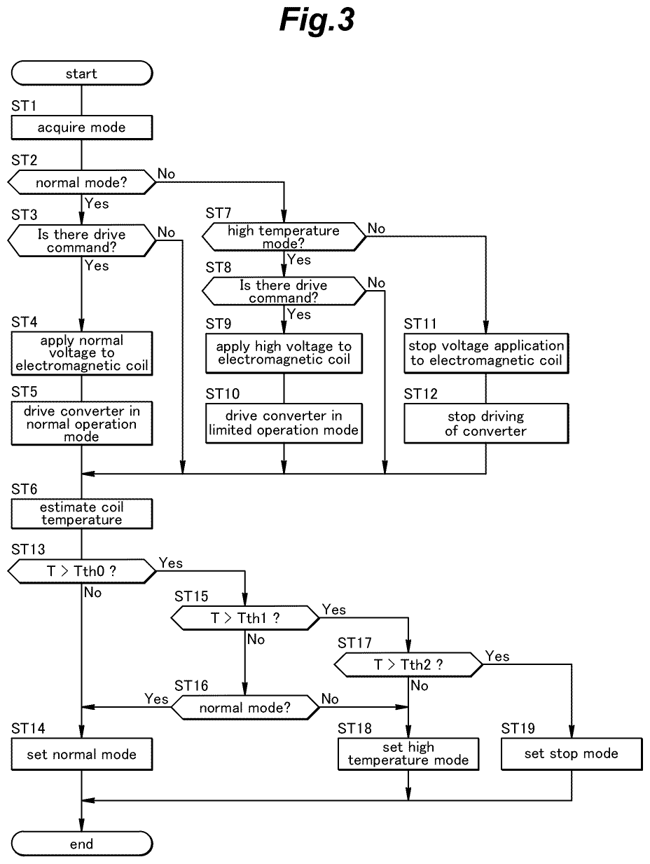

Next, with reference to FIG. 3, a procedure of contactor control performed by the ECU 10 will be described. FIG. 3 is a flowchart showing a procedure of contactor control performed by the ECU 10. Note that in FIG. 3, a decision-making process is indicated by a preparation symbol represented by a hexagon instead of a decision symbol represented by a rhombus.

When activated, the ECU 10 repeatedly executes the process shown in FIG. 3 at a predetermined control period. Note that since the ECU 10 executes the same control for the first contactor 6A and the second contactor 6B, in the following, description will be made of the contactor 6 without distinguishing between the first and second contactors.

When activated, the ECU 10 first acquires a mode stored in the memory (step ST1). The mode means a drive mode of the contactor 6 set by the ECU 10 depending on the coil temperature T estimated as described later, and there are three modes consisting of a normal mode, a high temperature mode, and a stop mode. As an initial mode to be acquired after activation, the normal mode is set in the memory.

The ECU 10 determines whether the acquired mode is the normal mode (step ST2). When the acquired mode is the normal mode (ST2: Yes), the ECU 10 determines whether there is a drive command (step ST3). The drive command may be a drive command corresponding to accelerator pedal operation by the driver or a drive command from a device for controlling automatic driving.

When it is determined in step ST3 that there is a drive command (Yes), the ECU 10 controls the contactor driving circuit 15 to apply a normal voltage to the electromagnetic coil 14 in order to close the contactor 6 (step ST4). The normal voltage is a voltage set beforehand as a voltage necessary to bring the movable contact 13 into the closed state when the temperature of the electromagnetic coil 14 in an appropriate range.

Further, the ECU 10 drives the converter 5 in a normal operation mode to drive the load 3 (step ST5). The normal operation mode is an operation mode in a normal state for driving the load 3 to output a driving force according to the drive command.

Subsequently, the ECU 10 estimates the coil temperature T of the electromagnetic coil 14 (step ST6). As described above, the estimation of the coil temperature T is performed by the ECU 10 based on the resistance of the electromagnetic coil 14, which is calculated based on the voltage applied to the electromagnetic coil 14 and the electric current detection value detected by the current sensor 19. When it is determined in step ST3 that there is no drive command (No), the ECU 10 executes the process of step ST6 without executing the processes of step ST4 and step ST5.

When it is determined in step ST2 that the acquired mode is not the normal mode (No), it is determined whether the acquired mode is the high temperature mode (step ST7). When the acquired mode is the high temperature mode (ST7: Yes), the ECU 10 determines whether there is a drive command (step ST8). When there is a drive command (ST8: Yes), the ECU 10 controls the contactor driving circuit 15 to apply a high voltage to the electromagnetic coil 14 in order to close the contactor 6 (step ST9). The high voltage is a voltage set beforehand as a voltage necessary to maintain the movable contact 13 in the closed state when the coil temperature T is in a predetermined high temperature range corresponding to the high temperature mode, and is higher than the normal voltage.

Further, the ECU 10 drives the converter 5 in a limited operation mode to drive the load 3 (step ST10). The limited operation mode is an operation mode with a limitation for driving the load 3 with the driving force limited to a predetermined value regardless of the drive command. When driving the converter 5 in the limited operation mode, the ECU 10 presents a warning indicating that the load 3 is being driven in the limited operation mode to the driver. The warning may be a warning lamp displayed on the instrument panel, a warning display in a multi-information display (MID), a warning buzzer, a voice guide, etc., for example.

Thereafter, the ECU 10 executes the process of step ST6. In the case where it is determined in step ST8 that there is no drive command (No), the ECU 10 executes the process of step ST6 without executing the processes of step ST9 and step ST10.

When it is determined in step ST7 that the acquired mode is not the high temperature mode (No), namely, when the acquired mode is the stop mode, the ECU 10 stops the voltage application to the electromagnetic coil 14 regardless of the presence or absence of the drive command (step ST11). Thereby, the contactor 6 is opened. The stop mode is a mode set for stopping the driving of the load 3 when the coil temperature T is above the predetermined high temperature range. Also, the ECU 10 stops the driving of the converter 5 (step ST12). Thereafter, the ECU 10 executes the process of step ST6.

After estimating the coil temperature T in step ST6, the ECU 10 determines whether the coil temperature T exceeds a reference threshold temperature Tth0 (step ST13). In the case where the coil temperature T does not exceed the reference threshold temperature Tth0 (ST13: No), the ECU 10 sets the normal mode as the mode stored in the memory (step ST14), and ends this routine.

When it is determined in step ST13 that the coil temperature T exceeds the reference threshold temperature Tth0 (Yes), the ECU 10 determines whether the coil temperature T exceeds a first threshold temperature Tth1 (step ST15). The first threshold temperature Tth1 is a temperature set beforehand as a temperature at which the mode should be switched from the normal mode to the high temperature mode when the coil temperature T is rising, and is higher than the reference threshold temperature Tth0.

When it is determined in step ST15 that the coil temperature T does not exceed the first threshold temperature Tth1 (No), the ECU 10 determines whether the current mode acquired in step ST1 is the normal mode (step ST16). When the current mode is the normal mode (ST16: Yes), the ECU 10 executes the process of step ST14 to set the normal mode as the mode stored in the memory.

When it is determined in step ST15 that the coil temperature T exceeds the first threshold temperature Tth1 (ST15: Yes), the ECU 10 determines whether the coil temperature T exceeds a second threshold temperature Tth2 (step ST17). The second threshold temperature Tth2 is a temperature set beforehand as a temperature above which the load 3 should be stopped, and is higher than the first threshold temperature Tth1.

When it is determined in step ST17 that the coil temperature T does not exceed the second threshold temperature Tth2 (No), the ECU 10 sets the high temperature mode as the mode stored in the memory (step ST18), and ends this routine. Also, in the case where it is determined in step ST16 that the current mode is not the normal mode (ST16: No), namely, when the current mode is the high temperature mode, the ECU 10 executes the process of step ST18 to set the high temperature mode as the mode stored in the memory.

In other words, the reference threshold temperature Tth0 which is lower than the first threshold temperature Tth1 is set as a temperature at which the high temperature mode should be released and be switched to the normal mode when the drive mode of the contactor 6 is the high temperature mode and the coil temperature T is lowering. Since a hysteresis is provided in the threshold for releasing the high temperature mode, hunting of the contactor drive mode is prevented.

When it is determined in step ST17 that the coil temperature T exceeds the second threshold temperature Tth2 (Yes), the ECU 10 sets the stop mode as the mode stored in the memory (step ST19), and ends this routine. In a routine following this routine, the mode set in step ST14, step ST18, or step ST19 is read in step ST1 to be acquired by the ECU 10.

The ECU 10 of the converter system 1 controls the contactor 6 as described above. In the following, the effects of the converter system 1 thus configured will be described.

Before describing the operation and effects of the converter system 1 according to the embodiment, the configuration and operation of a converter system 101 of a comparative example is described.

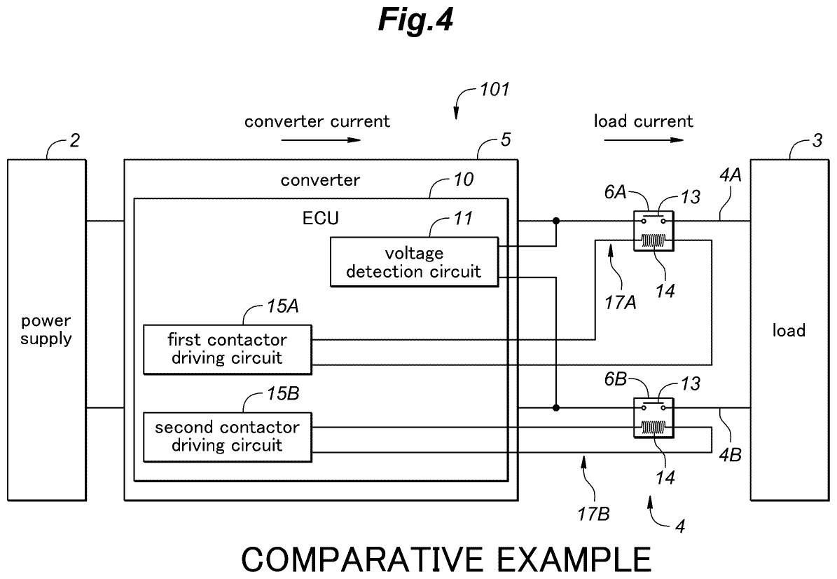

FIG. 4 is a block diagram showing a functional configuration of the converter system 101 according to the comparative example. Note that the elements same as or similar to those of the converter system 1 according to the embodiment are denoted by the same reference signs, and the description redundant with that of the first embodiment will be omitted.

As shown in FIG. 4, this converter system 101 differs from the converter system 1 according to the embodiment in that the converter system 101 is not provided with the first current sensor 19A and the second current sensor 19B (see FIG. 1), but is configured similarly in other respects. Since this converter system 101 is not provided with the first current sensor 19A and the second current sensor 19B, the electric current for driving the first contactor driving circuit 15A and the second contactor driving circuit 15B cannot be detected. In other words, the ECU 10 of the converter system 101 cannot detect the contactor drive current flowing from the first contactor driving circuit 15A or the second contactor driving circuit 15B to the electromagnetic coil 14 of the corresponding contactor 6.

Therefore, in this converter system 101, the ECU 10 cannot estimate the temperature of the electromagnetic coil 14 based on the contactor drive current detected during the operation of the converter 5. Accordingly, when the temperature of the electromagnetic coil 14 becomes high and the resistance of the electromagnetic coil 14 becomes large, there is a possibility that an open malfunction in which the contactor 6 inadvertently opens can occur.

In contrast to this, the converter system 1 according to the present embodiment shown in FIG. 1 is configured such that, in step ST6 of FIG. 3, the ECU 10 estimates the coil temperature T of the electromagnetic coil 14 based on the electric current detection value detected by the current sensor 19. Therefore, even though a thermistor is not provided in the contactor 6, the ECU 10 can prevent the open malfunction of the contactor 6. Also, since there is no need to provide a thermistor in the contactor 6, it is possible to achieve both suppression of increase of cost of the converter system 1 and prevention of the open malfunction of the contactor 6.

When it is determined in step ST15 that the coil temperature T exceeds the first threshold temperature Tth1 which is set beforehand (Yes), the ECU 10 sets the high temperature mode in step ST18, so that the voltage applied to the electromagnetic coil 14 is increased in step ST9. Thereby, the open malfunction of the contactor 6 due to a rise in the coil temperature T can be prevented while the conduction of the first power supply path 4 is maintained.

When it is determined in step ST17 that the coil temperature T exceeds the second threshold temperature Tth2 which is set beforehand (Yes), the ECU 10 sets the stop mode in step ST19, so that the voltage application to the electromagnetic coil 14 is stopped in step ST11. Thereby, the contactor 6 is opened to interrupt the first power supply path 4 before the open malfunction of the contactor 6 due to a rise in the coil temperature T occurs.

Further, the second threshold temperature Tth2 is set to be higher than the first threshold temperature Tth1. When it is determined in step ST17 that the coil temperature T exceeds the second threshold temperature Tth2 (Yes), the ECU 10 stops the voltage application to the electromagnetic coil 14 in step ST11. Thus, the conduction of the first power supply path 4 is maintained while the open malfunction of the contactor 6 due to a rise in the coil temperature T is prevented, and when the coil temperature T becomes higher, the first power supply path 4 is interrupted so that the open malfunction of the contactor 6 is reliably prevented.

Concrete embodiments have been described in the foregoing, but the present invention can be modified in various ways without being limited to the above embodiments or modifications. For example, in the above embodiment, the load 3 is a traveling motor, an inverter, etc. of an automobile, but the load 3 may be another driving device of the automobile or a drive unit, electric equipment, etc. of a moving body other than the automobile, an industrial machine, or the like. Also, only one of the first contactor 6A and the second contactor 6B may be provided as the contactor 6. In this case, the ECU 10 only needs to be provided with the corresponding current sensor 19. Besides, the concrete structure, arrangement, number, or the like of each member or part may be appropriately changed without departing from the spirit of the present invention. Also, not all of the components shown in the foregoing embodiments are necessarily indispensable and they may be selectively adopted as appropriate.

1. A contactor system, comprising:
a contactor provided on a power supply path connecting a power supply and a load, the contactor comprising a normally open movable contact for selectively establishing/interrupting the power supply path and an electromagnetic coil for driving the movable contact;
a contactor driving circuit electrically connected to the electromagnetic coil to drive the contactor;
a current sensor for detecting a contactor drive current flowing from the contactor driving circuit to the electromagnetic coil; and
a controller configured to control the contactor driving circuit so as to apply a voltage to the electromagnetic coil to close the contactor and so as to stop voltage application to the electromagnetic coil to open the contactor,
wherein the controller is configured to estimate a coil temperature of the electromagnetic coil based on the contactor drive current detected by the current sensor.

2. The contactor system according to claim 1, wherein the controller calculates a resistance of the electromagnetic coil based on the voltage applied to the electromagnetic coil and the contactor drive current, and estimates the coil temperature of the electromagnetic coil based on the resistance.

3. The contactor system according to claim 2, wherein the controller estimates the coil temperature by referring to a map showing a relationship between the resistance and the coil temperature.

4. The contactor system according to claim 1, wherein the controller increases the voltage applied to the electromagnetic coil when the coil temperature exceeds a first threshold temperature that is set beforehand.

5. The contactor system according to claim 1, wherein the controller controls the contactor driving circuit to stop the voltage application to the electromagnetic coil when the coil temperature exceeds a second threshold temperature that is set beforehand.

6. The contactor system according to claim 4, wherein the controller controls the contactor driving circuit to stop the voltage application to the electromagnetic coil when the coil temperature exceeds a second threshold temperature that is set beforehand, the second threshold temperature being higher than the first threshold temperature.

7. A contactor control method in a contactor system,
the contactor system comprising:
a contactor provided on a power supply path connecting a power supply and a load, the contactor comprising a normally open movable contact for selectively establishing/interrupting the power supply path and an electromagnetic coil for driving the movable contact;
a contactor driving circuit electrically connected to the electromagnetic coil to drive the contactor; and
a current sensor for detecting a contactor drive current flowing from the contactor driving circuit to the electromagnetic coil,
the contactor control method comprising:
controlling the contactor driving circuit to apply a voltage to the electromagnetic coil when to close the contactor and to stop voltage application to the electromagnetic coil when to open the contactor;
estimating a coil temperature of the electromagnetic coil based on the contactor drive current detected by the current sensor; and
controlling the contactor driving circuit according to the coil temperature.

8. The contactor control method according to claim 7, wherein the contactor driving circuit is controlled to increase the voltage applied to the electromagnetic coil when the coil temperature exceeds a first threshold temperature that is set beforehand.

9. The contactor control method according to claim 7, wherein the contactor driving circuit is controlled to stop the voltage application to the electromagnetic coil when the coil temperature exceeds a second threshold temperature that is set beforehand.

10. The contactor control method according to claim 8, wherein the contactor driving circuit is controlled to stop the voltage application to the electromagnetic coil when the coil temperature exceeds a second threshold temperature that is set beforehand, the second threshold temperature being higher than the first threshold temperature.
